(19) United States
(12) Patent Application Publication
(10) Pub. No.: US 2009/0004392 A1
(43) Pub. Date: Jan. 1, 2009

(54) Transiently Inhibited Urea And Urethane-Urea Hybrid Coating Compositions

(75) Inventors: Chad H. Volkmer, Willowick, OH (US); Thomas J. Staunton, Euclid, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/145,613

(22) Filed: Jun. 25, 2008

Related U.S. Application Data
(60) Provisional application No. 60/946,535, filed on Jun. 27, 2007.

(51) Int. Cl. B05D 3/02; C08G 18/00

(52) U.S. Cl. 427/385.5; 525/452

(57) ABSTRACT

A solvent borne, curable coating composition includes a resin formed to have an amine functional moiety, and, optionally, a hydroxyl functional compound; at least one polyisocyanate, and; at least one volatile, salt-forming organic acid and an inert solvent. The compositions may further include an organometallic catalyst. It is believed that the volatile organic acid temporarily drives the formation of amine salts in the composition, thereby inhibiting amine/isocyanate crosslinking, and, where an organometallic catalyst is present, inhibits catalysis. Both of these inhibitory effects are reversed upon acid evaporation, which may substantially occur after the composition has been applied to a substrate. The delay in crosslinking achieved by use of the acid, however, may facilitate more complete evaporation of solvents from the coating, resulting in improved coating properties.

This application claims priority from U.S. Provisional Application 60/946,535 filed Jun. 27, 2007, the entirety of which is incorporated herein by reference.

### I. BACKGROUND OF THE INVENTION

Two-component curable coating compositions comprising polyisocyanates and active hydrogen containing compounds are well known in the art. In many such compositions, processing and application protocols dictate the use of inert organic solvents to modify the viscosity of the compositions, for example, to make the compositions sprayable. Volatile solvents are preferred because it is generally desirable that the solvents evaporate from the coating. If significant amounts of solvent are trapped in the coating, the coating may suffer from physical defects, such as solvent popping and, aesthetic defects, such as opaqueness or cloudiness. These defects can be difficult, time consuming and expensive to correct.

Compositions comprising resins having reactive amine moieties, and particularly, primary amine moieties, are especially challenging to process and apply, even using sophisticated two-component equipment, because of the rapid reactivity of amines with polyisocyanates. It is particularly troublesome to devise, process and apply compositions that have a sufficient open time after application to allow for adequate solvent evaporation.

Notwithstanding the challenges that the use of amine moieties presents, their rapid reactivity with isocyanate can be a useful property for achieving a high production output of coated parts and can provide desirable coating properties. The highly reactive amine moieties can quickly form a film that is durable enough to permit handling of the part, which may, accordingly, be set aside for further curing, as necessary.

### II. SUMMARY OF THE INVENTION

The present invention describes an elegant approach for transiently inhibiting the formation of urea crosslinks in a coating composition that comprises a resin having amine functional compounds and at least one polyisocyanate by means of a volatile organic acid. The presence of the acid in the coating composition may temporarily inhibit crosslinking of the amine moieties and the isocyanates by initially driving a reaction of the primary or secondary amine moieties toward the formation of the respective amine salts, which are substantially non-reactive with isocyanate. This temporarily reduces the number of free reactive amine moieties to react with the polyisocyanate. Under conditions that allow for or facilitate subsequent evaporation of the acid, amine moieties are increasingly freed to crosslink, thus, the inhibiting effect of the acid on the amine moieties is transient.

Desirably, the bulk of the acid evaporation will occur after a substrate has been sprayed with the composition and more desirably, the delay in crosslinking imparted by the acid may be sufficient to allow for greater evaporation of the inert solvents from the coating. In this respect, it may be useful to select a volatile acid having a slower evaporation rate than all of the volatile solvents in the composition. Alternatively, or in addition thereto, it may be desirable to use a sufficient excess of acid to drive the salt reaction, even despite ongoing evaporation of the acid, until the other solvents have substantially evaporated from the coating. By employing acids of varying volatilities and quantities, it may be possible to develop designer compositions in which the acid or acid blend is selectively matched with a particular solvent or solvent blend so as to achieve optimal open time.

Still other benefits and advantages of the invention will become apparent to those skilled in the art to which it pertains upon a reading and understanding of the following detailed specification.

### III. DETAILED DESCRIPTION OF THE INVENTION

The present invention relates to a solvent borne, curable coating composition comprising:
(i) a resin comprising an amine functional compound, and, optionally, a hydroxyl functional compound,
(ii) at least one polyisocyanate, and
(iii) at least one volatile, salt-forming organic acid, which may be a carboxylic acid.

The composition may further comprise organometallic catalysts.

Importantly, the resin may comprise compounds having either primary or secondary amine functionality or both.

When utilized as a coating or an adhesive, the curable composition of this invention may be used in combination with about 5 to about 80% by weight of an inert solvent or solvent blend. In one useful embodiment, the curable composition is used in combination with about 10 to about 40%, by weight of an inert solvent. Solvents, or solvent blends chosen for use in the present invention may be selected to have evaporation rates similar to, and in certain useful embodiments, greater than (i.e., evaporating faster than), the evaporation rate of at least one of the volatile organic acids used in the curable composition.

The curable compositions of this invention are useful as coatings and may typically be utilized as primers, topcoats or as clearcoats and/or basecoats in clearcoat/basecoat compositions and are especially useful in spray applications, though the composition may be applied to a substrate by dipping, brushing, rolling, or other conventional means. The compositions of this invention could also be utilized as adhesives, elastomers and plastics.

It has been observed that in some embodiments vitrification can be selectively delayed by use of the volatile organic acid, which it is believed both initially drives the formation of amine salts in the composition, thereby inhibiting amine/isocyanate crosslinking by reducing the availability of “free” reactive amine, and, where organometallic catalyst is present, additionally inhibits catalysis. The use of carboxylic acids to extend open time and pot life in organotin catalyzed polyurethane reactions is taught in U.S. patent application Ser. No. 11/753,171, which is incorporated herein by reference. Both of these inhibitory effects are reversed upon evaporation of the acid, which may substantially occur after the composition has been applied to a substrate. Advantageously, the extended open time achieved by use of the acid may facilitate more complete evaporation of volatile solvents from the coating, resulting in improved coating properties. Ancillary benefits may include extended usable potlife.

The present invention also describes a method for transiently inhibiting the formation of urea linkages in a coating having as starting materials an amine functional resin and at least one polyisocyanate.

The composition will now be described in further detail.

Resin

The coating compositions of the present invention include a resin containing at least one amine functional compound, preferably, one or more oligomers or polymers having two or more primary or secondary amine moieties or a combination thereof per molecule. For purposes herein, the term polyamine is deemed to include diamines.

Representative examples of useful polyamines include, but are not limited to, ethylene diamine, 1,2-diaminopropane, 1,4-diaminobutane, 1,3-diaminopentane, 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′ and/or 4,4′-diaminodicyclohexyl methane, and 3,3′-dialkyl-4,4′-diamino-dicyclohexyl methanes such as 3,3′-dimethyl-4,4-diamino-dicyclohexyl methane and 3,3′-diethyl-4,4′-diaminodicyclohexyl methane; aromatic polyamines such as 2,4- and/or 2,6-diaminotoluene and 2,6-diaminotoluene and 2,4′ and/or 4,4′-diaminodiphenyl methane; polyoxyalkylene polyamines (also referred to herein as amine terminated polyethers); and cycloaliphatic polyamines such as isophoronediamine, 1,2-diaminocyclohexane and bis-p-aminocyclohexylmethane. Examples of trifunctional amines may include nitrilotrialkylamine, including nitrilotriethaneamine, dialkylenetriamines, including diethylenetriamine, trialkylenetetramines and tetraalkylenepentamines, the alkylene moieties may be ethylene moieties. Furthermore, dendrimers may be used as amines.

Particularly useful polyamines include the cycloaliphatic, difunctional or trifunctional amines, and more usefully are those having a molecular weight, determined by gel permeation chromatography relative to polystyrene, in the range from about 200 to about 4000.

Blends of polyamines may be selected to balance physical properties of the coating or composition. Moreover, blends of compounds having primary and secondary amine functionality may be selected, though in some embodiments, it may be useful to have only primary amine functionality and in other embodiments, it may be useful to have only secondary amine functionality.

The resin may, optionally, comprise one or more hydroxyl functional compounds, namely, oligomers or polymers having two or more reactive hydroxyl groups per molecule, and preferably, two (diols) or three (triols) hydroxyl groups. Such polyols useful in the resin composition may include, but are not limited to, polyether polyols, particularly those having a molecular weight, determined by gel permeation chromatography, in the range from 500 to 5000; polyester polyols, particularly those having a molecular weight in the range from 500 to 5000; polyester polyether polyols, particularly those having a molecular weight of 500 to 5000; acrylic polyols with a degree of polymerization of 3 to about 50 and a molecular weight of 360 to 6000; glycols with a molecular weight in the range from 120 to about 250, and mixtures of the forgoing.

By way of example, the polyester polyols may comprise those formed from adipic acid, phthalic acid, isophthalic acid or terephthalic acid, as well as castor oil formed from glycerin and castor fatty acid, and glycols and triols such as ethylene glycol, neopentyl glycol and trimethylol propane; the polyether polyols may comprise polypropylene glycols, polyethylene glycols, polytetramethylene glycols; and the glycols may comprise propylene glycol, neopentyl glycol, hexanediol, and butanediol.

Suitable polyester polyols include those formed from diacids, or their monoester, diester, or anhydride counterparts, and diols. The diacids may be saturated C₄-C₁₂ aliphatic acids, including branched, unbranched, or cyclic materials, and/or C₈-C₁₅ aromatic acids. Examples of suitable aliphatic acids include, for example, succinic, glutaric, adipic, pimelic, suberic, azelaic, sebacic, 1,12-dodecanedioic, 1,4-cyclohexanedicarboxylic, and 2-methylpentanedioic acids. Examples of suitable aromatic acids include, for example, terephthalic, isophthalic, phthalic, 4,4′-benzophenone dicarboxylic, and 4,4′-diphenylamine dicarboxylic acids. The diols may be C₂-C₁₂ branched, unbranched, or cyclic aliphatic diols. Examples of suitable diols include, for example, ethylene glycol, 1,3-propylene glycol, 1,2-propylene glycol, 1,4-butandediol, 1,3-butandediol, hexanediols, 2-methyl-2,4-pentanediol, cyclohexane-1,4-dimethanol, and 1,12-dodecanediol. In one embodiment of the invention, the polyol used in making the polyester polyol is a polyether with a molecular weight in the range from 200 to 2000 and a functionality of 2 to 3.

Suitable polyether polyols include polyoxy-C₂-C₆-alkylene polyols, including branched and unbranched alkylene groups. Examples of suitable polyether diols include, for example, polyethylene oxide, poly(1,2- and 1,3-propyleneoxide), poly(1,2-butyleneoxide), and random or block copolymers of ethylene oxide and 1,2-propylene oxide.

Suitable polyester polyether polyols have a molecular weight of 500 to 5000 and a functionality of 2 to 3. They may be made from polyethers with a molecular weight of 200 to 2000 and a functionality of 2 to 3, with acids, for example, such as adipic acid, phthalic acid, isophthalic acid or terephthalic acid.

Suitable acrylic polyols include polyols based on monoethylenically unsaturated monomers, such as monoethylenically unsaturated carboxylic acids and esters thereof, styrene, vinyl acetate, vinyl trimethoxysilane, and acrylamides; including but not limited to methyl acrylate, butyl acrylate, ethyl acrylate, 2-ethylhexyl acrylate, hydroxylbutyl acrylate, hydroxyethyl acrylate, glycidyl acrylate, lauryl acrylate, and acrylic acid. The polymers may be homopolymers or copolymers. The copolymers may also contain significant portions of methacrylate monomers, for example, methyl methacrylate, butyl methacrylate, hydroxyethyl methacrylate, lauryl methacrylate, glycidyl methacrylate and methacrylic acid.

A particularly useful resin may comprise a blend of amine and hydroxyl functional compounds. In such an embodiment, the resin may comprise a blend of distinct amine functional and hydroxyl functional compounds, or the resin may comprise compounds having both amine and hydroxyl functionality, or the resin may comprise both classes of compounds, depending on the desired physical characteristics of the composition. In one embodiment, the ratio of hydroxyl to amine moieties in the resin may be from about 0.5:1 to about 10:1, with a ratio of about 3:1 being particularly useful.

The composition may include a suitable catalyst used for the reaction of active hydrogen containing compounds and isocyanates. Suitable catalysts for this reaction include, for example, tertiary amines, and metal catalysts. Typical metal catalysts may include tin, zinc, copper and bismuth materials such as dibutyl tin dilaurate, stannous octanoate, dibutyl tin diacetate, dibutyl tin dilaurate, dibutyl tin oxide, tetrabutyl-1,3-diacetoxydistannoxane, zinc octoate, copper naphthenate, bismuth octoate and the like. In one useful embodiment, organometallic tin catalysts, and particularly dibutyltin dilaurate, are used in the practice of this invention and may be used in amounts from about 0.001% to about 0.5% with respect to total resin solids.

The coating composition may include an inert organic solvent ranging from about 1.0-90%, and preferably about 1.0-50%, and in other embodiments about 5.0-80% and in still others, about 40-80% by weight based upon the total weight of the coating. Useful inert organic solvents for the coating composition include aromatic hydrocarbons such as toluene, xylene, ethyl benzene, aromatic naphtha, etc.; aliphatic hydrocarbons such as mineral spirits, hexane, aliphatic naphtha, etc.; esters such as butyl acetate, ethylene glycol monoethyl ether acetate, ethylene glycol monobutyl ether acetate, etc.; and ketones such as methyl amyl ketone and methyl isobutyl ketone.

Polyisocyanates

The composition may include any isocyanate functional molecule conventionally used in facilitating crosslinking in polyurethane or polyurea films. Typical isocyanate functional molecules useful in the compositions of this invention will have an average of at least two isocyanates per molecule, and more usefully three isocyanates per molecule. Representative polyisocyanates useful in the present invention include the aliphatic compounds such as ethylene, trimethylene, tetramethylene, pentamethylene, hexamethylene, 1,2-propylene, 1,2-butylene, 2,3-butylene, 1,3-butylene, ethylidene and butylidene diisocyanates; the cycloalkylene compounds such as 3-isocyanatomethyl-3,5,5-trimethylcyclohexylisocyanate, and the 1,3-cyclopentane, 1,3-cyclohexane, and 1,2-cyclohexane diisocyanates; the aromatic compounds such as m-phenylene, p-phenylene, 4,4-diphenyl, 1,5-naphthalene and 1,4-naphthalene diisocyanates; the aliphatic-aromatic compounds such as 4,4-diphenylene methane, 2,4- or 2,6-toluene or mixtures thereof, 4,4′-toluidine, and 1,4-xylylene diisocyanates; the nuclear substituted aromatic compounds such as dianisdine diisocyanate, 4,4′-diphenylether diisocyanate and chlorodiphenylene diisocyanate; the triisocyanates such as triphenyl methane-4,4′,4″-triisocyanate, 1,3,5-triisocyanatebenzene and 2,4,6-triisocyanate toluene; and the tetraisocyanates such as 4,4′-diphenyl-dimethyl methane-2,2′,5,5′-tetraisocyanate; the polymerized polyisocyanates such as dimers and trimers, and other various polyisocyanates containing biuret, urethane, and/or allophanate linkages.

Particularly useful polyisocyanates include dimers and trimers of hexamethylene diisocyanate, isophorone diisocyanate, and mixtures thereof. A particularly useful polyisocyanate comprises a blend of hexamethylene diisocyanate (HDI) and isophorone diisocyanate (IPDI) trimers. In one embodiment, the molar ratio of HDI trimers to IPDI trimers may be about 4:1.

Organic Acids

According to the present invention, the composition will further include a volatile salt-forming organic acid. The term “volatile acid” refers to an acid that will, under curing conditions, evaporate from the composition as sprayed on the substrate. Desirably, the acid will substantially completely evaporate from the coating prior to vitrification, meaning that it will evaporate to such an extent that physical defects in the coating will not be attributable to the presence of trapped acid. The term “salt-forming” refers to the suitability of the acid to participate in a reaction with at least one amine moiety in the resin to form the amine salt. Such an acid may be referred to as an amine-salt forming acid.

The term “salt-forming amount” refers to that amount of the volatile organic acid sufficient to inhibit the reaction of the functional amine moieties in the resin and the polyisocyanate by driving the formation of amine salts in the composition. It will be understood that the amount of volatile organic acid that constitutes a “salt-forming amount” for a particular composition will depend on many variables, such as the type of organic acid selected, the resin composition, anticipated mixing conditions, and the like. Notwithstanding, a useful equivalents ratio of volatile acid to amine moieties may be from about 0.01:1 to about 1.5:1. Preferably, this ratio is about 1:1 or greater; however the benefits of salt formation may be seen in compositions not containing an excess of acid equivalents. In some embodiments, it may be useful to provide an equivalents ratio of acid to amine that is greater than 1.5:1 or greater than 2.0:1 or greater than 3.0:1. Using large excesses of acid may drive the salt formation despite ongoing evaporation of the acid.

Particularly useful volatile salt forming organic acids include volatile fatty acids, including, for example, formic acid, acetic acid, propionic acid, butyric acid, isobutyric acid, valeric acid, isovaleric acid, hexanoic acid, heptanoic acid, and octanoic acid, etc, and blends thereof.

As discussed above, it is contemplated that the compositions of the present invention may include one or a blend of volatile solvents. These solvents may serve to modify the viscosity of the composition to facilitate application methods. It will be particularly useful if the volatile salt forming organic acid or acid blend is selected in such manner as to inhibit vitrification until such time as the volatile solvents have substantially completely evaporated from the coating. In this respect, at least one volatile salt forming organic acid may be selected which has lower volatility than the least volatile of the volatile solvents used in the composition. It will be understood, however, that in certain embodiments it will be useful if the volatile salt forming organic acid is selected to have only slightly less volatility than the least volatile of the volatile solvents so that crosslinking is not untimely delayed after substantially all of the volatile solvents have evaporated.

In some embodiments it will be useful if the volatile organic acid comprises at least one acid that also inhibits the catalytic activity of one or more of the catalysts, described above. By selecting a volatile acid or acid blend that both inhibits amine isocyanate reactivity by means of the aforementioned salt formation, and inhibits catalysis, significant delay in crosslinking can be achieved.

The acid may be blended with the resin prior to the addition of the isocyanate functional hardener. In another embodiment, the acid may be added to the resin following addition of the isocyanate functional hardener. While not preferred, it may be useful in some cases to include the acid with the isocyanate functional hardener.

Additives

The compositions of the present invention may include one or more conventional additives selected to improve composition and film characteristics such as flow additives, fillers, release agents, pigments, heat and light stabilizers, antioxidants, plasticizers and so forth.

If used as coatings, the curable compositions can be used as clear coatings or they may contain pigments as is well known in the art. Representative opacifying pigments include white pigments such as titanium dioxide, zinc oxide, antimony oxide, etc. and organic or inorganic chromatic pigments such as iron oxide, carbon black, phthalocyanine blue, etc. The coatings may also contain extender pigments such as calcium carbonate, clay, silica, talc, etc.

In one embodiment, the curable composition may have a sprayable viscosity, at room temperature, of less than about 25 seconds, or less than about 20 seconds, when measured by a #2 Zahn cup and when formulated to a VOC level of 3.5#/gallon. It is convenient to provide the curable composition as a multicomponent system which is reactive upon mixing the components. Generally, the resin and the polyisocyanate will be maintained in separate packages and mixed just prior to use. The metal catalyst can be incorporated into either component. Other optional additives may be mixed with either component, or added to the curable composition after the components have been mixed.

The curable compositions of this invention can be cured at temperatures ranging from about 55° F. up to about 350° F. In one embodiment, the curable composition will cure completely (dry to buff) in less than five (5) minutes at a temperature less than or equal to 160° F. Drying of curable compositions of the present invention may be expedited by applying heat and/or radiation to the coated substrate. For example, oven baking, application of UV radiation, or application of infrared radiation. In one embodiment, the curable composition may be applied to a substrate as a coating and then have infrared radiation applied to the coated surface at a temperature of about 160° F. for about 2 to about 3 minutes.

The coatings of this invention may typically be applied to any substrate such as metal, plastic, wood, glass, synthetic fibers, etc, by brushing, dipping, roll coating, flow coating, spraying or other method conventionally employed in the coating industry. If desired, the substrates may be primed prior to application of the coatings of this invention. Spraying is one preferred application process. Usefully, compositions according to the present invention provide coatings having excellent physical characteristics evidencing substantial evaporation of the solvents and acid may be achieved even in coatings comprising primary amine functional resins. The acid appears to cause the film to remain open, even for high solid applications, long enough for sufficient solvent evaporation to minimize die-back and solvent popping and other potential film problems. If desired, the substrates may be primed prior to application of the coatings of this invention.

One preferred application of the curable compositions of this invention relates to their use as clearcoats and/or basecoats in clearcoat/basecoat formulations. Low VOC clearcoats are an especially useful application of this invention.

Clearcoat/basecoat systems are well known, especially in the automobile industry where it is especially useful to apply a pigmented basecoat, which may contain metallic pigments, to a substrate and allow it to form a film followed by the application of a clearcoat. The basecoat composition may be any of the polymers known to be useful in coating compositions including the reactive compositions of this invention.

Typically the basecoat will include pigments conventionally used for coating compositions and after being applied to a substrate, which may or may not previously have been primed, the basecoat will be allowed sufficient time to form a polymer film which will not be lifted during the application of the clearcoat. The basecoat may be heated or merely allowed to air-dry to form the film. Generally, the basecoat will be allowed to dry for about 1 to 20 minutes before application of the clearcoat. The clearcoat is then applied to the surface of the basecoat, and the system can be allowed to dry at room temperature or, if desired, can be force dried by baking the coated substrate at temperatures typically ranging up to about 350° F.

Typically, the clearcoat may contain ultraviolet light absorbers such as hindered amines at a level ranging up to about 6% by weight of the vehicle solids as is well known in the art. The clearcoat can be applied by any application method known in the art, but preferably will be spray applied. If desired, multiple layers of basecoat and/or clearcoat can be applied. Typically, both the basecoat and the clearcoat will each be applied to give a dry film thickness of about 0.2 to about 6, and especially about 0.5 to about 3.0, mils.

The following examples have been selected to illustrate specific embodiments and practices of advantage to a more complete understanding of the invention. Unless otherwise stated, “parts” means parts-by-weight and “percent” is percent-by-weight.

### EXAMPLE 1

A clearcoating may be prepared by admixing the following materials:

| | | Solids | |
|---|---|---|---|
| | Total Weight | Weight | |
| | (grams) | (grams) | Equivalents/type |
| Alicyclic 2° diamine | 24.35 | 24.35 | 0.1917/NH |
| (254 g/mol, 127 g.eq NH) | | | |
| Hydroxyl functional acrylic | 365.06 | 255.55 | 0.5604/OH |
| copolymer (app. 2500 Mn, | | | |
| 456 g/eq OH) | | | |
| Additives | | | |
| Silicone resin | 2.11 | 1.06 | |
| BZT UVA/HALS | 13.41 | 13.41 | |
| DBTDL | 0.48 | 0.48 | .000760/Sn |
| Diluents/Solvents | | | |
| n-Butyl Acetate | 123.51 | | |
| Acetone | 860.16 | | |
| MAK | 52.03 | | |
| Toluene | 28.69 | | |
| PM Acetate | 64.17 | | |
| Hardeners | | | |
| HDI trimer | 121.08 | 121.08 | |
| IPDI Trimer | 79.95 | 55.96 | |
| Volatile Acids | | | |
| Acetic Acid | 12.17 | | 0.2028/COOH |
| Propionic Acid | 2.04 | | 0.02757/COOH |

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

We claim:

1. A coating composition comprising
an amine functional compound,
a volatile organic acid;
a polyisocyanate; and
an inert organic solvent.

2. The coating composition of claims 1, further comprising a hydroxyl functional compound.

3. The coating composition of claim 1, wherein the volatile organic acid is a carboxylic acid.

4. The coating composition of claim 3, wherein the volatile organic acid is selected from the group consisting of acetic acid, propionic, heptanoic acid and blends thereof.

5. The coating composition of claim 1, wherein the organic solvent has a higher evaporation rate than the volatile organic acid.

6. The coating composition of claim 3, wherein the amine functional compound has primary amine functionality.

7. The coating composition of claim 6, further comprising an organometallic tin catalyst.

8. The coating composition of claim 7, wherein the amine functional compound is substantially free of secondary amine functionality.

9. The coating composition of claim 3, wherein the amine functional compound has secondary amine functionality.

10. The coating composition of claim 9, wherein the amine functional compound is substantially free of primary amine functionality.

11. The coating composition of claim 10, wherein the polyisocyanate is selected from the group consisting of hexamethylene diisocyanate, isophorone diisocyanate, and mixtures thereof.

12. A coating composition comprising
an amine functional compound;
a hydroxyl functional compound;
a volatile organic acid;
at least one polyisocyanate; and
at least one inert solvent; and
wherein the ratio of hydroxyl functional moieties to amine functional moieties is between about 0.5:1 and about 10:1

13. The coating composition of claim 12, wherein the ratio of equivalents of volatile organic acid to functional amine moieties is between about 0.01:1 and about 3.0:1.

14. The coating composition of claim 13, wherein the ratio of equivalents of volatile organic acid to functional amine moieties is about 1:1 or greater.

15. The coating composition of claim 12, further comprising an organometallic catalyst.

16. The coating composition of claim 15, wherein the organometallic catalyst comprises 0.001% to about 0.5% with respect to total resin solids.

17. The coating composition of claim 12, wherein the volatile organic acid is selected from the group consisting of acetic acid, propionic, heptanoic acid and blends thereof.

18. The coating composition of claim 12, wherein a least one volatile organic acid has an evaporation rate that is lower than the evaporation rate of all inert solvents in the composition.

19. A method for applying a curable film to a substrate, the method comprising the steps of:
providing a curable film forming prepolymer composition, comprising
an amine functional compound;
at least one amine-salt forming acid in an equivalents ratio with respect to amine moieties in the amine functional compound of about 1:1 or greater;
At least one polyisocyanate; and
At least one inert solvent;
Depositing a layer of the film forming prepolymer composition to the substrate; and
Curing the layer of the film forming prepolymer composition.

20. The method of claim 19, wherein the curable film forming prepolymer composition further comprises an ultraviolet light absorber.

21. The method of claim 19, wherein the amine-salt forming acid and the inert solvent are selected to substantially completely evaporate from the composition during curing, and, wherein the evaporation rate of the amine-salt forming acid under curing conditions is lower than the evaporation rate of the inert solvents under curing conditions.

22. A composition comprising
an amine functional compound having a molecular weight of from about 200 to about 4000,
an amine-salt forming acid, wherein the amount of amine-salt forming acid is in an equivalents ratio with respect to amine moieties in the composition of from about 0.01:1 to about 3.0:1; and
a polyisocyanate.

23. The composition of claim 22, wherein the amine-salt forming acid is a carboxylic acid.

24. The composition of claim 23, wherein the amine-salt forming acid is selected from the group consisting of acetic acid, propionic acid, heptanoic acid, and blends thereof.

25. The composition of claim 23, wherein the amount of amine-salt forming acid is in an equivalents ratio with respect to amine moieties in the resin of about 1:1.

26. The composition of claim 25, wherein the amine-salt forming acid is a volatile acid.

27. The composition of claim 22 further comprising from about 40% to about 80% by weight based upon the total weight of the composition, of one or more inert solvents.

28. The composition of claim 27, wherein the evaporation rate of the amine-salt forming acid under curing conditions is lower than the evaporation rate of the inert solvents under curing conditions.

29. The composition of claim 22, wherein the amine functional group is a secondary amine functional group.

30. The composition of claim 29, wherein the resin is substantially free of primary amine functionality.
